(19) United States
(12) Patent Application Publication
(10) Pub. No.: US 2024/0281668 A1
(43) Pub. Date: Aug. 22, 2024

(54) DOCUMENT CLASSIFICATION USING LARGE LANGUAGE MODELS

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/111,638

(22) Filed: Feb. 20, 2023

(51) Int. Cl. G06N 5/022; G06F 16/33; G06F 18/2415; G06F 40/166; G06F 40/247; G06F 40/295; G06F 40/35; G06F 40/58

(52) U.S. Cl. CPC G06N 5/022; G06F 16/3344; G06F 18/2415; G06F 40/166; G06F 40/247; G06F 40/295; G06F 40/35; G06F 40/58

(57) ABSTRACT

A system and a method for classifying text from a document using an ensemble of close ended questions and a neural network based large language model, which might have been trained for different purposes. The method comprising feeding the language model with queries based on the text and the ensemble and post processing output of the language model using a knowledge representation rule based model or an additional machine language model. The method may be used as spam or phishing filter, detect sensitive contents due to various criteria, and/or the like.

### FIELD AND BACKGROUND OF THE INVENTION

The present invention, in some embodiments thereof, relates to text classification, and, more particularly, but not exclusively, usage of generative conversational language models as text classifiers.

Text classification may be wanted for the purpose of security and sensitive word filtering, as well as Sentiment Analysis, i.e. classifying text into different categories such as positive, negative, or neutral, Spam and scam filtering, Topic classification such as classifying text into different topics, such as sports, politics, or entertainment, and the like.

Text filters based on keyword search and templates are style sensitive and fail to interpret phrasing variations. This limits spam filters, ability to detect sensitive information, Some machine learning models are successful in language classification and named entity recognition (NER), however still require large sets of labeled data.

### SUMMARY OF THE INVENTION

It is an object of the present invention to provide a system and a method for classifying text using an ensemble of close ended questions and a conversational language model.

According to an aspect of some embodiments of the present invention there is provided one or more computer program products comprising instructions for classifying a textual content, wherein execution of the instructions by one or more processors of a computing system is to cause a computing system to:
receive a textual content;
access a storage to obtain a plurality of close ended questions;
generate a plurality of queries, each from a combination of the textual content and one of the plurality of close ended questions;
acquire a plurality of inference values each generated by feeding one of the plurality of queries to at least one conversational language model;
feed a structure combining the plurality of inference values into a decision model to acquire a classification of the textual content; and
output an indication of the classification in association with the textual content.

According to an aspect of some embodiments of the present invention there is provided a system comprising a storage and at least one processing circuitry configured to:
receive a textual content;
access the storage to obtain a plurality of close ended questions;
generate a plurality of queries each from a combination of the textual content and one of the plurality of close ended questions;
acquire a plurality of inference values each generated by feeding one of the plurality of queries to at least one conversational language model;
feed a structure combining the plurality of inference values into a decision model to acquire a classification of the textual content; and
output an indication of the classification in association with the textual content.

According to an aspect of some embodiments of the present invention there is provided a method for classifying a textual content, comprising:
receiving a textual content;
accessing a storage to obtain a plurality of close ended questions;
generating a plurality of queries each from a combination of the textual content and one of the plurality of close ended questions;
acquiring a plurality of inference values each generated by feeding one of the plurality of queries to at least one conversational language model;
feeding a structure combining the plurality of inference values into a decision model to acquire a classification of the textual content; and
outputting an indication of the classification in association with the textual content.

Optionally, the decision model comprising a classifying machine learning model.

Optionally, the decision model comprises converting the structure to a plurality of logic indications and a rule based model, comprising comparing a weighted or conditioned accumulation of the logic indications to a threshold.

Optionally, the plurality of close ended questions comprises a binary question.

Optionally, the at least one conversational language model comprises at least one generative transformer network, and at least one autoregressive component.

Optionally, the plurality of close ended questions comprising at least one pair of synonymous questions.

Optionally, the plurality of close ended questions is based on at least one domain knowledge checklist.

Optionally, further comprising a language adaptation module, the language adaptation module translates the textual content from a first language to a second language.

Optionally, the language adaptation module further comprising a domain specific adaptation module, replacing at least one subsequence of text with a corresponding subsequence of text.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for text classification, according to some embodiments of the present disclosure;

FIG. 2 is a schematic diagram of a simplified exemplary text classification module, according to some embodiments of the present disclosure;

FIG. 3 is a flowchart of an exemplary process for text classification, according to some embodiments of the present disclosure;

FIG. 4 is a screenshot excerpt from an exemplary experiment using a conversational language model, according to some embodiments of the present disclosure; and

FIG. 5 is another screenshot excerpt from an exemplary experiment using a conversational language model, according to some embodiments of the present disclosure.

### DESCRIPTION OF SPECIFIC EMBODIMENTS OF THE INVENTION

The present invention, in some embodiments thereof, relates to text classification, and, more particularly, but not exclusively, usage of generative conversational language models as text classifiers.

Some embodiments of the present invention feed a language model with queries prepared using an ensemble of close ended questions on a text extracted from a document, a clip, a recording, and/or the like to be classified, and process inferences from the language model to classify the text.

Some embodiments of the present invention provide stronger articulation robustness compared to want could otherwise be obtained using limited labeled data.

Some embodiments of the present invention analyze attention to mark sensitive parts in text, and may suggest safer replacements.

Some embodiments of the present invention may provide accuracy improvement using different formulation for questions, and provide high accuracy based on weaker assumptions on the language model strength.

Some embodiments of the present invention receive text directly or apply extraction thereof form a video, a vocal recording, and/or the like.

Some embodiments of the present invention may apply pre-processing such as translation and filter text for known weaknesses of the translation and/or the conversational language model. The conversational language model may be a large language model trained for various purposes which may not necessarily comprise text classification.

Some embodiment of the present invention wrap the text with queries prepared for a classification, and apply a pre-trained conversational language mode, which may be transformer neural network based, in the wrapped text.

Some embodiment of the present invention extract closed ended inferences from a text generated by the model, and apply a preset function or an additional machine learning model to produce classification of the text.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

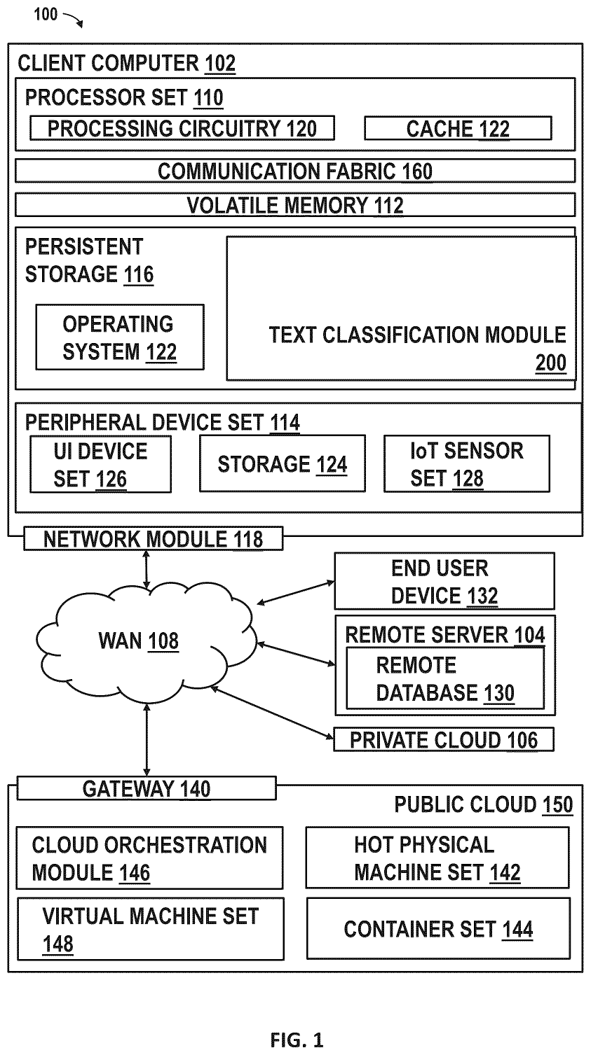

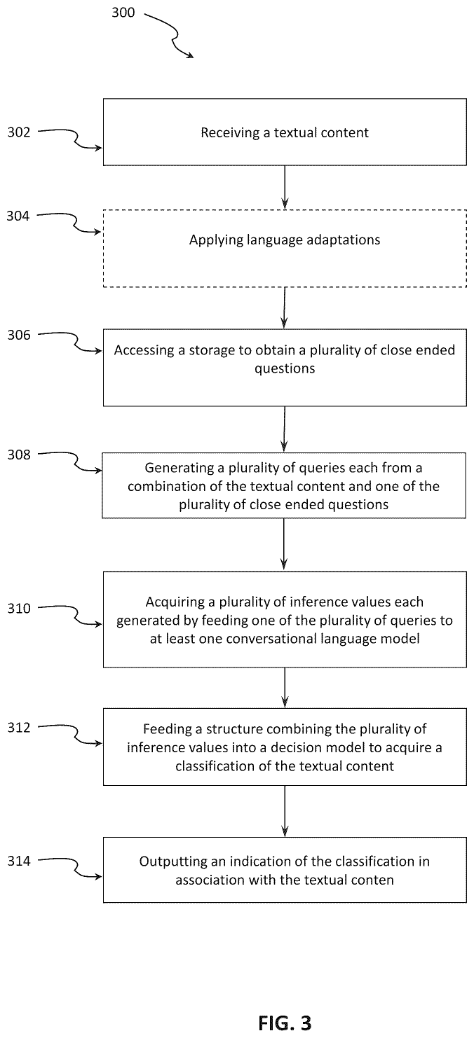

Referring now to the drawings, FIG. 1 is a schematic illustration of an exemplary system for text classification, according to some embodiments of the present disclosure. An exemplary client computer system 100 may be used for executing execute processes such as 300 for text classification. Further details about these exemplary processes follow as FIG. 3 are described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a text classification module 200. In addition to block 200, computing environment 100 includes, for example, computer 102, wide area network (WAN) 108, end user device (EUD) 132, remote server 104, public cloud 150, and private cloud 106. In this embodiment, computer 102 includes processor set 110 (including processing circuitry 120 and cache 134), communication fabric 160, volatile memory 112, persistent storage 116 (including operating system 122 and block 200, as identified above), peripheral device set 114 (including user interface (UI), device set 126, storage 124, and Internet of Things (IoT) sensor set 128), and network module 118. Remote server 104 includes remote database 130. Public cloud 150 includes gateway 140, cloud orchestration module 146, host physical machine set 142, virtual machine set 148, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. For example, a processor set may include one or more of a central processing unit (CPU), a microcontroller, a parallel processor, supporting multiple data such as a digital signal processing (DSP) unit, a graphical processing unit (GPU) module, and the like, as well as optical processors, quantum processors, and processing units based on technologies that may be developed in the future. Processing circuitry 120 may be distributed over multiple packages, for example, multiple, coordinated integrated circuit chips. Processing circuitry 120 may implement multiple processor threads and/or multiple processor cores. Cache 134 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 134 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 116.

COMMUNICATION FABRIC 160 is the signal conduction paths that allow the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 116 is any form of non-volatile storage for computers that is now known or to be developed in the future. The non-volatility of this storage means that the stored data is maintained regardless of whether power is being supplied to computer 102 and/or directly to persistent storage 116. Persistent storage 116 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 126 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 128 is made up of sensors that can be used in Internet of Things applications. For example, one sensor may be a thermometer and another sensor may be a motion detector.

NETWORK MODULE 118 is the collection of computer software, hardware, and firmware that allows computer 102 to communicate with other computers through WAN 108. Network module 118 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 118 are performed on the same physical hardware device. In other embodiments (for example, embodiments that utilize software-defined networking (SDN)), the control functions and the forwarding functions of network module 118 are performed on physically separate devices, such that the control functions manage several different network hardware devices. Computer readable program instructions for performing the inventive methods can typically be downloaded to computer 102 from an external computer or external storage device through a network adapter card or network interface included in network module 118.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 132 is any computer system that is used and controlled by an end user (for example, a customer of an enterprise that operates computer 102), and may take any of the forms discussed above in connection with computer 102. EUD 132 typically receives helpful and useful data from the operations of computer 102. For example, in a hypothetical case where computer 102 is designed to provide a recommendation to an end user, this recommendation would typically be communicated from network module 118 of computer 102 through WAN 108 to EUD 132. In this way, EUD 132 can display, or otherwise present, the recommendation to an end user. In some embodiments, EUD 132 may be a client device, such as thin client, heavy client, mainframe computer, desktop computer and so on.

REMOTE SERVER 104 is any computer system that serves at least some data and/or functionality to computer 102. Remote server 104 may be controlled and used by the same entity that operates computer 102. Remote server 104 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 104.

PUBLIC CLOUD 150 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 150 is performed by the computer hardware and/or software of cloud orchestration module 146. The computing resources provided by public cloud 150 are typically implemented by virtual computing environments that run on various computers making up the computers of host physical machine set 142, which is the universe of physical computers in and/or available to public cloud 150. The virtual computing environments (VCEs) typically take the form of virtual machines from virtual machine set 148 and/or containers from container set 144. It is understood that these VCEs may be stored as images and may be transferred among and between the various physical machine hosts, either as images or after instantiation of the VCE. Cloud orchestration module 146 manages the transfer and storage of images, deploys new instantiations of VCEs and manages active instantiations of VCE deployments. Gateway 140 is the collection of computer software, hardware, and firmware that allows public cloud 150 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 150, except that the computing resources are only available for use by a single enterprise. While private cloud 106 is depicted as being in communication with WAN 108, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture 5 is bound together by standardized or proprietary technology that enables orchestration, management, and/or data/application portability between the multiple constituent clouds. In this embodiment, public cloud 150 and private cloud 106 are both part of a larger hybrid cloud.

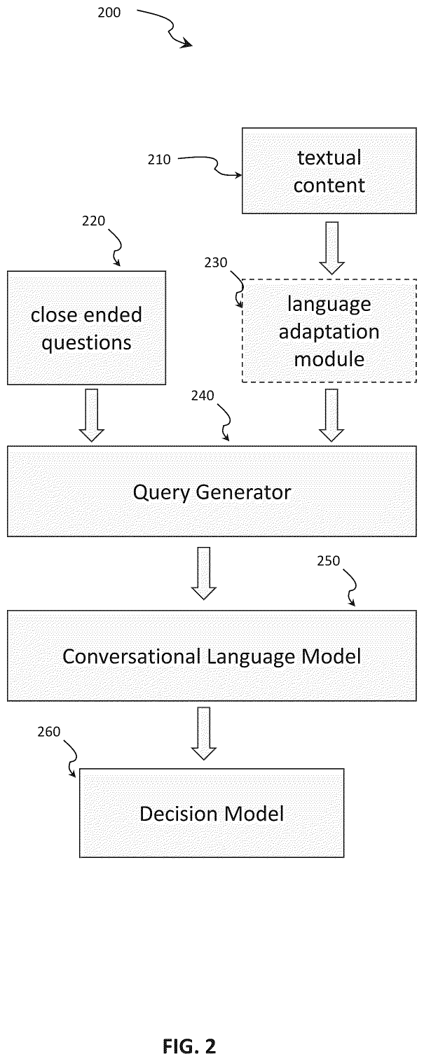

Referring now to FIG. 2, which is a schematic diagram of a simplified exemplary text classification module, according to some embodiments of the present disclosure.

The diagram describes the primary essential and an optional architectural component of the text classification module 200.

The textual content 210 may be received from an end user device 132, the public cloud 150, the UI device set 126, and/or the like, and it may be a text message, an email, a letter, a blog post, a question, and/or the like.

The textual content may also be entered or received as text, or extracted from a voice recording, a video, and/or the like. The textual content may be in a variety of languages, dialects, jargons, and the likes.

Some implementations of the disclosure, for example those used on languages other than English, which have lesser representation in available training data, and thus handled less effectively, may comprise a language adaptation module, for translating the textual content from a first language to a second language.

The language adaptation module 230 may be used to translate a text from a first language to a second language. The first language be a language of a small country, a minority language, a jargon, or the like, which may be characterized by lesser presence in the training data of the conversational language model, therefore the language model may perform better on the second language. The second level may be English, however some implementations may use another second language such as Spanish, German, Mandarin Chinese, as well as non-natural languages.

Some implementations may further comprise a domain specific adaptation module, for replacing at least one subsequence of text with a corresponding subsequence of text.

For example, the word “ [symbol] ” (long) in Mandarin Chinese may refer to dinosaur in a biological paper, however automatically translated to “dragon”. As another example, some Japanese to English translation models convert the term for ‘public cloud’ in Japanese to the English term ‘Hyperscaler’, which indeed refers to a feature associated, however is not the typical term one would use in English nowadays to describe a commercial public cloud, hence the conversational language model might have encountered fewer usages thereof during training, and may be more likely to err thereabout. Similarly, in many languages there is not a term for cogs different than teeth.

Other examples may relate to frequently used acronyms, abbreviations, jargon, local slang, deliberate typos used to avoid text filters and/or the like. Some implementation may also apply adaptations on incomplete sentences, though in some examples the conversational language model may be robust thereto.

The close ended questions 220 may be based on one or more checklists to verify a text is sensible to send. The plurality of close ended questions may be based on one or more domain knowledge checklists, questionnaires, key point lists, and/or the like.

In some implementations, the plurality of close ended questions comprises one or more ensembles of close ended questions which relate to a similar subject.

In some implementations, the plurality of close ended questions comprise pairs, trios, and/or larger sets of synonymous, or near synonymous questions, for reducing the risk of mistakes by the model. Other questions may be partially overlapping to existing ones in the question list.

Some checklists may comprise questions for making sure taboo subjects are not present. culturally or socially sensitive topics that are preferably avoided such as physical personal issues, medical conditions, mortality, religion, politics, race and ethnicity, substance abuse and addiction, social status, unlawful deeds, judgement about appearance or body, personal finance, family issues, and/or the like. These may be examples of close ended questions comprising binary. Yes/No question.

Other checklists may relate to company confidential and proprietary information. For classification of internal corporate documents, core criteria may relate to containing procedures, new training, salary changes, a seminar, and/or the like.

Examples for such questions comprise “Does the document include signatures?”, “Does it mention any agreement?”, “Does the document address two or more parties/entities that are involved?”, “Does it mention any policy?”, “Is this document an instruction?”, “Does it list any external email address?”, “Does it mention any customer or supplier name?”, and “Does the document mention any payment for services or products?”.

Another checklist for a similar, or a higher, more sensitive classification such as “secret” may comprise question such as: “Does the text discuss legal issues, lawsuits, legal claims or violations of contracts?”, “Does the text discuss intellectual property matters?”, “Does the text discuss or mention company names or product names?”, “Does the short text mention negotiations, pricing, discounts?”, “Does the text discuss organizational changes, new appointments, hiring or firing?”, “Are there passwords or IP addresses or usernames in the text”, “Are there personal details such as addresses, ID numbers, bank accounts in the text?”, “Does the text discuss commercial offers, bids or pre bid qualifications?”, “Does the text discuss Company procedures?”, “Does the text include contact details of external entities”, “Does the text include information about customers”, and/or the like.

Some implementations may allow classification override, for example, when a text mentions a big organizational change in a customer, but the change was made public in the media”

The questions may be formed from sources other than checklists, or questionnaires, and may have arbitrary valence and correlations to the associated inference of the text class.

The query generator 240 is used for generating a plurality of queries each from a combination of the textual content and one of the plurality of close ended questions.

For example, when the text is “Hi Danielle, what do you want to order for lunch”, some queries to the model may be “Does the text ‘Hi Danielle, what do you want to order for lunch’ contain controversial words”, “Does the text ‘Hi Danielle, what do you want to order for lunch’ mention bank accounts”, and/or the like.

Some implementation may split the text to several, partially overlapping and/or non-overlapping parts, and generate queries by applying some or all of the plurality of close ended questions on these parts. In some example the option to break textual contents into separate, potentially overlapping text parts such as sentences, paragraphs and/or the like, and ask the closed ended questions on those and then merge the results in the decision module may improve accuracy and robustness, since large language models may have weaknesses. Some implementations may apply parsing based on end of paragraph indications such as newline, a period at a sentence end, a comma, and/or the like. Some implementations of large language models may omit one or more references from the processing of comparatively long documents, and splitting documents to paragraphs, sentences, or parts thereof may reduce the risk of skipping a reference.

For example, a text like “I know Jack well, he is a Harvard graduate and we spent time together in college. He is going to be the next CFO coming March. I remember he had a crush on Becky, and that was quite a story”

While a human may immediately understand the ‘sensitive’ part is not that Jack went to Harvard, but rather his coming appointment. Yet some large language models may answer the close ended question “Is there information in the text about appointments” incorrectly when the whole paragraph is entered, but may answered correctly when asked sentence by sentence on “He is going to be the next CFO coming March”.

Other methods of merging text with questions may be used, such as, combining in an embedding space.

The conversational language model 250 may be an artificial intelligence module designed to generate text based on a given prompt or input. The model may be an incorporated in house or third party machine learning model, which was trained on a large corpus of text and may use deterministic or statistical techniques to generate outputs that are coherent, contextually relevant and semantically meaningful. The language model may be designed to analyze a natural language text and generate responses such as those expected in human conversation. The conversational language may be trained specifically for text classification, however models trained for variety of applications, such as chat-bots, virtual assistants, private tutor or psychotherapist emulation and customer service systems may also be used.

Conversational and other generative language models may be powered by advanced machine learning techniques, such as neural networks, and may be fine-tuned to perform specific tasks or to generate outputs in specific domains. Conversational language models may comprise components such as generative transformer network, for example for embedding a word placement in a sentence. Some generative language models comprise one or more autoregressive components, however deterministic methods may also be used.

The models may also be integrated into other systems to provide enhanced capabilities, such as improved natural language processing, text generation, and dialogue management. Followingly, the inferences from the language model may be acquired to form a structure to feed into a decision model to acquire a classification of the textual content.

The decision model 260 may receive a plurality of inference values, each generated by feeding one of the plurality of queries to the conversational language model, and process them to infer the text class. Which may be output as an indication of the classification in association with the textual content.

Some inferences may be binary, for example, positive or negative. Other examples may have an inference of multiple possible values such as “safe”, “low risk”, “high risk”, and “obvious attack”, or “unclassified”, “confidential” and “secret”.

For example, email messages relating to specific customers, specific contact details, commercial activity, non-disclosure agreements (NDA) may be classified as “secret” rather than merely “confidential”.

Some implementations may be checklist based, and a rule such as “when two or more answers are positive, indicate the text is taboo, otherwise indicate as safe”. Other implementations may indicate a text is suspicious when 1 to 3 answers are positive, and “high risk” when 4 or more positive answers reflect dubious indications.

These are examples of decision models comprises converting the structure to a plurality of logic indications and a rule based model, comprising comparing a weighted or conditioned accumulation of the logic indications to a threshold.

Some other implementations may comprise a classifying machine learning model, i.e. based on an additional machine learning model trained on labelled examples, and/or using other training methods such as active learning to allow less investment in supervision or clustering.

Referring now to FIG. 3, which is a flowchart of an exemplary process for text classification, according to some embodiments of the present disclosure. The processing circuitry 120 may execute the exemplary process 300 for a variety of purposes such as spam filtering, data security, internet web crawling, market research, and/or the like. Alternatively, the process 300 or parts thereof may be executing using a remote system, an auxiliary system, and/or the like.

The exemplary process 300 starts, as shown in 302, with receiving a textual content

The textual content, for example 210 may be received by the system through a user interface of the UI device set 126, network module 118, or other data input mechanism. The received text may be stored in volatile memory 112, cache, 122 peripheral storage 124, or the like, to be processed by the system for various applications, such as natural language processing based text classification.

The exemplary process 300 may continue, as shown in 304, with applying language adaptations, for example 230. Some implantations may comprise a comprising a language adaptation module, the language adaptation module may translate the textual content from a first language to a second language. A motivation may be that the close ended questions 220, the query generator 240, and/or the conversational language model 250 are apt for the second language, and thus correct inference is more likely therewith. It should also be noted that many natural language processing based translation methods, also referred to as Neural Machine Translation (NMT) such as Bidirectional Encoder Representations from Transformers (BERT) require less training data to achieve adequate reliability such as 90%, 95% or 99% than conversational models require, and are thus accessible for less ubiquitous languages.

The exemplary process 300 continues, as shown in 306, with accessing a storage to obtain a plurality of close ended questions. The plurality of close ended questions, for example 220, may be obtained from on volatile memory 112, peripheral storage 124, remotely on a private cloud 106, on non-volatile memory and/or the like. The close ended questions may be binary (Yes/No) or multiple choice, and may form a checklist or be related in any arbitrary manner, or apparent lack of relations.

The exemplary process 300 continues, as shown in 308, with generating a plurality of queries each from a combination of the textual content and one of the plurality of close ended questions. The queries may generated by a query generator such as 240, and may combine some or all of the questions from the plurality of questions such as 220 with parts or all of the textual content such as 210. The plurality of queries may be represented in comma separated value files, a list or array of strings, and/or the like, and each query may be in ASCII format, however Unicode, embedding, and other representations may be used.

The exemplary process 300 continues, as shown in 310, with acquiring a plurality of inference values each generated by feeding one of the plurality of queries to at least one conversational language model.

The conversational language model may be executed by the processor set 110, or remotely on the private cloud 106, or the public cloud 150, and/or the like.

The conversational language model such as 250 may be models such as or based on Generative Pretrained Transformer (GPT), Conditional Transformer Language Model (CTRL), Text-to-Text Transfer Transformer (T5), Recurrent neural networks (RNN), Generative Adversarial Networks (GANs), variational autoencoders, and/or the like, as well as models that are expected to be developed. Some implementations may also comprise a knowledge representation based module, which may be deterministic or stochastic. The conversational language model may generate answers which comprise one of a plurality of answers such as “Yes” and “No”, a number in a range, and/or the like, and these inferences may be fed directly or filtered to a decision model.

The exemplary process 300 continues, as shown in 312, with feeding a structure combining the plurality of inference values into a decision model to acquire a classification of the textual content.

Some inferences may be binary, for example, “Safe or “Unsafe”; “Positive” or “Negative” or “lingual correct” or “includes typos”. Other examples may have an inference of multiple possible values such as “safe”, “low risk”, “high risk”, and “obvious attack”, or “unclassified”, “confidential”, “Secret” and “Top Secret” For example, email messages relating to specific customers, specific contact details, commercial activity, non-disclosure agreements (NDA) may be classified as “secret” rather than merely “confidential”.

The decision may be based on comparing a count to a threshold, a decision tree, a machine learning model such as a random forest, a support vector machine, a neural network, and/or the like.

And subsequently, as shown in 314, the process 300 may continue by outputting an indication of the classification in association with the textual content. The indication may be showing the classification as text on a monitor, an associated sound, opening a dialog box, reporting to a log, and/or the like.

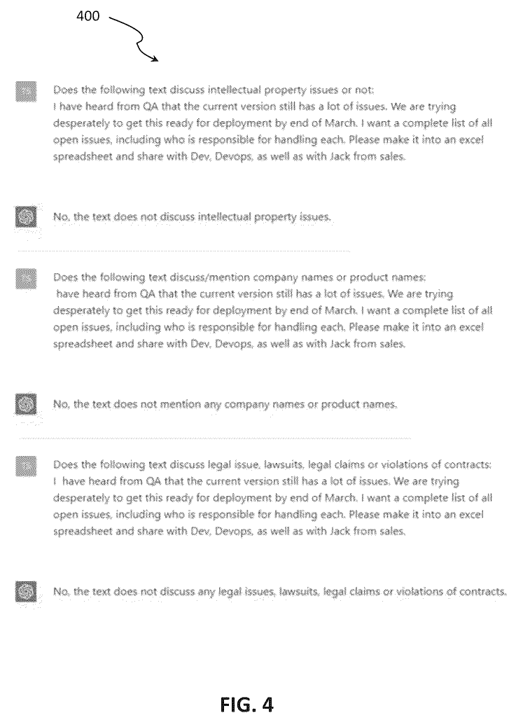

Referring now to FIG. 4, which is a screenshot excerpt from an exemplary experiment using a conversational language model, according to some embodiments of the present disclosure.

The results of a preliminary experiment on GPT 3 based chat as a conversational language model for the text classification module are shown. The purpose of the experiment was to evaluate the feasibility of the disclosure. As shown in 400 the results of the experiment demonstrate that the conversational language model of the module is correct in the majority of the responses, as well as grammatically and semantically appropriate for the given input.

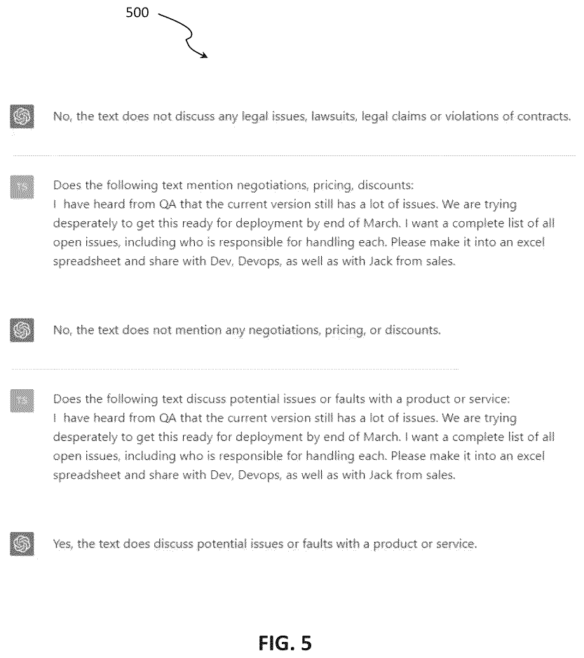

Referring now to FIG. 5, which is another screenshot excerpt from an exemplary experiment using a conversational language model, according to some embodiments of the present disclosure.

As shown in 500 the results of the experiment also demonstrate that the conversational language model of the module is usually correct and coherent.

Additional examples generated using the generative conversational language model GPT 3 based chat are shown below:

Dear Keith,

I am very concerned about the deal situation with JohnJoeJohnstonCo. We have not heard back from them for over one month. I'm afraid they are considering taking our competitors offer. I don't understand how we could not get any direct feedback from them about our current offer and schedule.

Please get back to me on that as soon as possible.

BR

Stacey

Does the short text discuss a commercial bidding process?—yes

Hi Martin,

I have heard from QA that the current version still has a lot of issues. We are trying desperately to get this ready for deployment by end of April. I want a complete list of all open issues, including who is responsible for handling each. Please make it into a spreadsheet and share with Dev, Devops, as well as with Jill from sales.

BR

Joan

Does the short text discuss a commercial bidding process?—no

It is expected that during the life of a patent maturing from this application many relevant conversational language models, text media, and representation methods will be developed and the scope of the terms conversational language models machine learning model, text, and embedding are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for classifying a textual content, comprising:
receiving a textual content;
accessing a storage to obtain a plurality of close ended questions;
generating a plurality of queries each from a combination of the textual content and one of the plurality of close ended questions;
acquiring a plurality of inference values each generated by feeding one of the plurality of queries to at least one conversational language model;
feeding a structure combining the plurality of inference values into a decision model to acquire a classification of the textual content; and
outputting an indication of the classification in association with the textual content.

2. The method of claim 1, wherein the decision model comprising a classifying machine learning model.

3. The method of claim 1, wherein the decision model comprises converting the structure to a plurality of logic indications and a rule based model, comprising comparing a weighted or conditioned accumulation of the logic indications to a threshold.

4. The method of claim 1, wherein the plurality of close ended questions comprises a binary question.

5. The method of claim 1, wherein the at least one conversational language model comprises at least one generative transformer network, and at least one autoregressive component.

6. The method of claim 1, wherein the plurality of close ended questions comprising at least one pair of synonymous questions.

7. The method of claim 1, wherein the plurality of close ended questions is based on at least one domain knowledge checklist.

8. The method of claim 1, further comprising a language adaptation module, the language adaptation module translates the textual content from a first language to a second language.

9. The method of claim 8, wherein the language adaptation module further comprising a domain specific adaptation module, replacing at least one subsequence of text with a corresponding subsequence of text.

10. A system comprising a storage and at least one processing circuitry configured to:
receive a textual content;
access the storage to obtain a plurality of close ended questions;
generate a plurality of queries each from a combination of the textual content and one of the plurality of close ended questions;
acquire a plurality of inference values each generated by feeding one of the plurality of queries to at least one conversational language model;
feed a structure combining the plurality of inference values into a decision model to acquire a classification of the textual content; and
output an indication of the classification in association with the textual content.

11. The system of claim 10, wherein the decision model comprising a classifying machine learning model.

12. The system of claim 10, wherein the decision model comprises converting the structure to a plurality of logic indications and a rule based model, comprising comparing a weighted or conditioned accumulation of the logic indications to a threshold.

13. The system of claim 10, wherein the plurality of close ended questions comprises a binary question.

14. The system of claim 10, wherein the at least one conversational language model comprises at least one generative transformer network, and at least one autoregressive component.

15. The system of claim 10, wherein the plurality of close ended questions comprising at least one pair of synonymous questions.

16. The system of claim 10, wherein the plurality of close ended questions is based on at least one domain knowledge checklist.

17. The system of claim 10, further comprising a language adaptation module, the language adaptation module translates the textual content from a first language to a second language.

18. The system of claim 17, wherein the language adaptation module further comprising a domain specific adaptation module, replacing at least one subsequence of text with a corresponding subsequence of text.

19. One or more computer program products comprising instructions for classifying a textual content, wherein execution of the instructions by one or more processors of a computing system is to cause a computing system to:
receive a textual content;
access a storage to obtain a plurality of close ended questions;
generate a plurality of queries each from a combination of the textual content and one of the plurality of close ended questions;
acquire a plurality of inference values each generated by feeding one of the plurality of queries to at least one conversational language model;
feed a structure combining the plurality of inference values into a decision model to acquire a classification of the textual content; and
output an indication of the classification in association with the textual content.
